(19) United States
(12) Patent Application Publication
(10) Pub. No.: US 2017/0283657 A1
(43) Pub. Date: Oct. 5, 2017

(54) METHOD FOR INCREASING THE ADHESION BETWEEN THE FIRST SURFACE OF A FIRST WEB-TYPE MATERIAL AND A FIRST SURFACE OF A SECOND WEB-TYPE MATERIAL

(71) Applicant: TESA SE, Norderstedt (DE)

(72) Inventor: Marcel HÄHNEL, Norderstedt (DE)

(73) Assignee: TESA SE, Norderstedt (DE)

(21) Appl. No.: 15/508,607

(22) PCT Filed: Sep. 1, 2015
(86) PCT No.: PCT/EP2015/069920

§ 371 Date: Mar. 3, 2017

(30) Foreign Application Priority Data
Sep. 5, 2014 (DE) 10 2014 217 800.2

(51) Int. Cl. C09J 5/02; B29C 65/00; B29C 65/48; C09J 7/00

(52) U.S. Cl. CPC C09J 5/02; C09J 7/00; B29C 66/028; B29C 66/723; B29C 66/81263; B29C 65/48; C09J 2201/606; C09J 133/08

(57) ABSTRACT

A method for increasing the adhesion between the first surface of a first web-type material and a first surface of a second web-type material, the first web-type material and the second web-type material being supplied to a lamination nip continuously and with the same direction of the web. In said nip, the first surface of the first web-type material and of the second web-type material are laminated together and both first surfaces are treated with a plasma over the whole surface. The lamination nip is formed by a pressure roller and a counter-pressure roller and at least one of the surfaces of the rollers or both are equipped with a dielectric. The first web-type material comprises an adhesive compound layer arranged in the first web-type material such as to form the first surface of the first web-type material.

This application is a 371 of PCT/EP2015/069920, filed Sep. 1, 2015, which claims foreign priority benefit under 35 U.S.C. §119 of the German Patent Application No. 10 2014 217 800.2, filed Sep. 5, 2014, the disclosures of which patent applications are incorporated herein by reference.

The invention pertains to a method for increasing the adhesion between the first surface of a first web-type material and a first surface of a second web-type material.

In the sector of industrial manufacture, the demand exists for simple pretreatment techniques in order to improve the adhesive bonding properties of an adherend.
Costly and inconvenient operations such as wet-chemical cleaning and priming of the adherend surface are typically used in order to obtain high-strength bonds with a self-adhesive tape.
In particular, the simple physical pretreatment techniques under atmospheric pressure (corona, plasma, flame) are nowadays used with advantage for the surface treatment of the adherend for the purpose of achieving a higher anchoring force with a self-adhesive tape.

To improve the adhesion properties of adherend surfaces and pressure-sensitive adhesive tape, it is possible to carry out pretreatments of the surfaces. These pretreatments mediate and/or strengthen the intermolecular forces of the bond partners. There are various possibilities of pretreatment, including chemical pretreatment by primer application or physical pretreatment by plasma or corona treatment.

An introduction to surface treatment is provided by the book “Kleben—Grundlagen, Technologien, Anwendungen” by G. Habenicht, 2009, Springer Verlag, Berlin/Heidelberg.

The strength of adhesive bonds, or the bond of surface to pressure-sensitive adhesive tape, can be strengthened by means of chemical bridges. The basis for these chemical bridges is provided by organosilicon compounds (silanes). As well as increased strength, they also permit improved aging relative to moist atmospheres. The chemical primer for this purpose is applied prior to the application of the pressure-sensitive adhesive tape on the surface. It is important here that the primer layer is extremely thin, in some cases monomolecular, since the intermolecular forces between the silane molecules are weak. The bifunctional adhesion promoter reacts subsequently with the adherend surface (polycondensation reaction) and with the adhesive molecules of the pressure-sensitive adhesive tape (polyaddition or addition-polymerization reaction).

The reaction mechanism is represented schematically in the appended drawing (see FIG. 7).

Plasma is the term for the 4^{th} aggregate state of matter. It comprises a partly or completely ionized gas. By supply of energy, positive and negative ions, electrons, other excited states, radicals, electromagnetic radiation, and chemical reaction products are generated. Many of these species can lead to changes to the surface to be treated. All in all, this treatment leads to activation of the adherend surface—specifically, to greater reactivity.

This treatment may be carried out both on the surface of the adherend and on the adhesive. A combination of both treatments is likewise possible. This treatment is also used to increase the adhesion between the first surface of a first web-type material (an adhesive, for example) and a first surface of a second web-type material (a carrier material, for example).

Corona treatment, also called corona discharge, takes the form of a high-voltage discharge with direct contact to the adherend surface. The discharge converts nitrogen in the ambient air into a reactive form. The collision of the impinging electrons on the adherend surface causes molecules to split. The resulting free valences permit accretion of the reaction products of the corona discharge. These accretions permit improved adhesion properties on the part of the adherend surface.

This treatment may, equivalently to the plasma, take place on adherend surface, adhesive of the pressure-sensitive adhesive tape, and, in combination, on both surfaces.

Where two or more than two layers are to be laminated to one another, one or both interfaces are typically pretreated physically prior to the lamination.

It is known that treatment by corona and plasma has a limited durability in terms of the activation of the boundary layer, and so treatment takes place at a time near to or, primarily, directly before the laminating operation.

Plasma and corona pretreatments are described or referred to for example in DE 2005 027 391 A1 and DE 103 47 025 A1.

DE 10 2007 063 021 A1 describes activation of adhesives by filamentary corona treatment. It is disclosed that the prior plasma/corona pretreatment is beneficial to the holding power and the flow-on behavior of the adhesive bond. It was not recognized that the process can produce an increase in the peel adhesion.

Like DE 10 2007 063 021 A1, DE 10 2011 075 470 A1 describes the physical pretreatment of adhesive and carrier/substrate. The pretreatments are carried out separately before the joining step and may be designed identically and differently. The double-sided pretreatment produces higher peel adhesion and anchoring forces than in the case of only substrate-side pretreatment.

In the case of DE 24 60 432 A, two webs are to be joined to a laminate by introduction of a plastic polymeric film which serves as an adhesion promoter. The plasma forms between the two laminating rolls, which are grounded, and a high-voltage electrode, which at the same time has a passage for the adhesion promoter. The air flowing around the roll is said to be influenced in form by the plasma so that the adhesion promoter does not cool too early and there are no inclusions of air in the laminate.

DE 27 54 425 A makes reference to DE 24 60 432 A. New arrangements are described for the same problem addressed. In this case, according to FIG. 1, the plasma is formed between the two laminating rolls, of which one has a dielectric covering. As in DE 24 60 432 A, only the lamination of flat-film webs by means of a thermoplastic polymer melt is described.

DE 198 46 814 A1 describes various arrangements which, in accordance with the stated objective, ensure improved corona treatment of the webs prior to lamination. Webs are referred to only generally, and the term “films” is stated only in connection with DE 198 02 662 A1. There is no naming of adhesives.

Here, again, the plasma according to claim 2 is formed between two laminating rolls. The dielectric is formed by at least one co-traveling belt.

DE 41 27 723 A1 describes the production of multilayer laminates of polymeric film webs and plastics plates, in which at least one joining side is treated with an aerosol corona directly ahead of the joining step. According to FIG. 1, this flow-driven corona may also be oriented directly at the laminating gap. Aerosols contemplated include monomers, dispersions, colloidal systems, emulsions or solutions.

A feature of the prior art is that the pretreatments relate predominantly to the carrier material or the adherend, in order to develop greater anchoring force to the adhesive or to the self-adhesive tape.

Although such plasma/corona treatments can be used to provide a clear boost to the anchoring forces relative to untreated band partners, a kind of limit is found in many systems which do not go into cohesive fracture, this limit being impossible to overcome with the corona and plasma systems to date.

As has been determined in the context of this invention, the reason for this lies in the nature of the adhesives and in their interaction with the substrates. Interaction here is mostly via charges or functional groups. These functional groups are generated on the surfaces by plasma pretreatment and are diverse and different in their nature. Essentially they come about immediately after the end of the contact between plasma and surface, as a result of reactions with atmospheric oxygen. These groups can be controlled partly, within narrow limits, by the process gases and process modes used. A significant boost, accordingly, is possible only if covalent bonds can be generated between the bond partners.

The issue which arises from this is whether it is possible, by means of an appropriate method regime, to generate these covalent bonds without the radicals reacting with gaseous components on the treated surfaces prior thereto.

It is an object of the invention to find the specified positive effects on physical surface modification of pressure-sensitive adhesives and carrier materials, in order to achieve high-strength bonds. The focal point of the invention is the achievement of high anchoring between the pressure-sensitive adhesive layer and the carrier material.

This object is achieved by means of a method as described hereinbelow.

The invention relates accordingly to a method for increasing the adhesion between the first surface of a first web-type material and a first surface of a second web-type material, wherein
the first web-type material and the second web-type material are fed continuously and with identical web direction to a laminating gap, in which the first web-type material and the second web-type material are laminated together each by their first surface,
both first surfaces of the first web-type material and of the second web-type material are treated over the full area with a plasma, specifically such that the plasma, beginning ahead of the laminating gap on into the laminating gap, acts continuously on the two first surfaces,
the laminating gap is formed by a pressure roll and a counter-pressure roll which develops a counter-pressure, and
at least one of the cylindrical surfaces of the rolls, or both, is or are furnished with a dielectric.

The first web-type material has a layer of adhesive which is arranged in the first web-type material in such a way that it forms the first surface of the first web-type material.

### BRIEF DESCRIPTION OF THE DRAWINGS

The invention will now be described in greater detail with reference to the drawings, wherein:

FIG. 1 shows a laminating gap formed by a pressure roll and by a counterpressure roll, which builds up the opposing pressure desired for lamination.

FIG. 2 shows an embodiment wherein both roll surfaces are equipped with a dielectric.

FIG. 3 shows an embodiment wherein a nozzle, which may be made of plastic, is present.

FIG. 4 represents a simplified detail of FIG. 3, showing only one quarter of the rolls.

FIG. 5 shows plasma being generated by a linear nozzle, on account of the voltage between the rolls and the nozzle.

FIG. 6 shows an alternative embodiment to FIG. 5, wherein the nozzle is replaced with a metallic wire that extends parallel to the laminating gap.

FIG. 7 shows an adhesion reaction mechanism schematically.

FIG. 8 is a graph depicting adhesive force as a function of haul-off speed; the “laboratory experiment” test takes place on the inventive system for plasma lamination.

It is essential to the invention that the plasma extends up to the line where the two web-type materials are laminated together.

In the context of the invention, a clear distinction is made between a corona treatment and a plasma treatment.

If plasma treatment is mentioned hereinafter, the reference is also in fact only to such a treatment.

The first and second web-type materials here run with identical web direction into the laminating gap.

Since the plasma is developed in the laminating gap, the first web-type material and the second web-type material are laminated together in the plasma each by their first surface.

According to a first preferred embodiment of the invention, an arbitrary point on the plasma-treated surface of the first web-type material and/or the second web-type material travels the path from the start of the plasma treatment on into the laminating gap in a timespan of less than 2.0 s, preferably less than 1.0 s, more preferably less than 0.5 s. Times of less than 0.5 s, preferably less than 0.3 s, more preferably less than 0.1 s are also possible in accordance with the invention.

According to one variant of the invention, a third web-type material is fed to the laminating gap such that the second web-type material lies between the first and third web-type materials.

The web direction of the third web-type material is the same as that exhibited by the first and second web-type materials.

In a further variant of the invention, the laminating gap is supplied not only with the first and second web-type materials but also with a multiplicity of further web-type materials, the feed taking place in such a way that the individual web-type materials enter the laminating gap between the first and second web-type materials. The individual further web-type materials are selected such that in the laminating gap a non-adhesive carrier layer and a second non-adhesive carrier layer are never laminated directly to one another.

The laminating gap is formed by a pressure roll and by a counter-pressure roll, which develops the counter-pressure desired for lamination. The rolls preferably run counter-rotatingly, more preferably at identical peripheral speed.

In the laminating gap, the peripheral speed and the direction of rotation of the rolls are identical to the web speed and web direction of the first and second web-type materials. Any further webs present, with further preference, likewise have identical web speed and web direction.

The rolls preferably have the same diameter, the diameter more preferably being between 50 to 500 mm. The cylindrical surface of the rolls is preferably smooth, and more particularly is ground.

The surface roughness of the rolls, Rₐ, is preferably less than 50 μm, preferably less than 10 μm. “Rₐ” is a unit for the industrial standard for the quality of final surface machining, and represents the average height of the roughness, more particularly the average absolute distance from the center line of the roughness profile within the region under evaluation.

The roll surface of the roll not covered with a dielectric may consist of steel, stainless steel or chromed steel. The surface may also have been plated with nickel or with gold. It ought only to be electrically conductive and to remain so under plasma exposure. The surface ought not to exhibit any corrosion under plasma exposure.

It is possible, furthermore, for one or both rolls to be heated or cooled in a preferred range from −40° C. to 200° C. using oil, water, steam, electrically, or with other thermal conditioning media. Preferably both rolls are unheated.

For the layer of the dielectric, which covers the entire cylindrical surface (also called, for simplification, surface) of one or both rolls, i.e., over the entire periphery of the roll(s), preference is given to selecting ceramic, glass, plastics, rubber such as styrene-butadiene rubbers, chloroprene rubbers, butadiene rubbers (BR), acrylonitrile-butadiene rubbers (NBR), butyl rubbers (IIR), ethylene-propylene-diene rubbers (EPDM), and polyisoprene rubbers (IR), or silicone.

The dielectric surrounds the roll(s) firmly, but may also be detachable, in the form of two half-shells, for example.

The thickness of the layer of the dielectric on the roll or rolls is preferably between 1 to 5 mm.

In accordance with the invention, the dielectric is not a co-traveling web which covers the cylindrical surface of one of the rolls only sectionally (or two co-traveling webs which cover cylindrical surfaces of both rolls only sectionally).

According to one preferred variant, only one roll of the roll pair forming the laminating gap is covered with a dielectric.

According to one preferred variant, both rolls of the roll pair which forms the laminating gap are covered with a dielectric.

The plasma is preferably generated between one or more nozzles and the rolls, preferably on operation with compressed air or N₂.

Plasma treatment takes place under a pressure which is close to (+/−0.05 bar) or at atmospheric pressure.

Plasma treatment may take place in various atmospheres, and the atmosphere may also comprise air. The treatment atmosphere may be a mixture of different gases, selected inter alia from N₂, O₂, H₂, CO₂, Ar, He, ammonia, and, additionally, steam or other constituents may have been admixed. This exemplary listing is not a limitation.

According to one advantageous embodiment of the invention, the following pure or mixed process gases form a treatment atmosphere: N₂, compressed air, O₂, H₂, CO₂, Ar, He, ammonia, ethylene, siloxanes, acrylic acids and/or solvents, and, additionally, steam or other volatile constituents may have been added. Preference is given to N₂ and compressed air.

The atmospheric pressure plasma may be formed from a mixture of process gases, in which case the mixture preferably contains at least 90 vol % nitrogen and at least one noble gas, preferably argon.

According to one preferred embodiment of the invention, the mixture consists of nitrogen and at least one noble gas, and with further preference the mixture consists of nitrogen and argon.

In principle it is also possible to admix coating or polymerizing constituents to the atmosphere, in the form of gas (ethylene, for example) or liquids (atomized as aerosol). There is virtually no restriction to the aerosols that are suitable. The plasma technologies which operate indirectly are especially suitable for use with aerosols, since in that case there is no risk of electrode fouling.

The proportion thereof, however, ought not to exceed 5 vol %.

Types of nozzles suitable in principle for generating the plasma and for acting on the web-type materials are all types of nozzle stated, provided the plasma acts continuously on into the laminating gap.

One possible variant of the plasma treatment is the use of a fixed plasma jet.

A likewise possible plasma treatment uses an arrangement of two or more nozzles, offset, if necessary, for the gap-less, partially overlapping treatment in sufficient width. In this case it is possible to use rotating or nonrotating circular nozzles.

Linear electrodes with gas exit opening are particularly suitable, and extend advantageously over the entire length of the laminating gap.

With further preference, these electrodes have a constant distance from the laminating gap over the entire length of the laminating gap.

According to a further variant, the plasma burns between the edge of a metallic plate, a metallic rod or a metallic wire, and the dielectrically lined rolls.

Here as well it is preferred if the edge of the plate, the rod or the wire are aligned parallel to the laminating gap.

With further preference the plasma generator is covered with an insulator apart from the outer edge pointing to the laminating gap.

According to another advantageous embodiment of the invention, the treatment distance of the plasma generator from the laminating gap is 1 to 100 mm, preferably 3 to 50 mm, more preferably 4 to 20 mm.

With further preference, the plasma generator can be shifted in its height perpendicular to the plane which is in turn perpendicular to the plane defined by the roll axes, and preferably can be displaced simultaneously in its height and in its distance from the laminating gap.

For further preference, the speed with which the webs are fed into the laminating gap is between 0.5 to 200 m/min, preferably 1 to 50 m/min, more preferably 2 to 20 m/min (in each case including the specified marginal values of the ranges).

According to one advantageous embodiment of the invention, the web speeds of the first, second, third or other web are all the same.

The first web-type material has a layer of adhesive which is arranged in the first web-type material in such a way that it forms the first surface of the first web-type material.

The first web-type material may be a double-sided adhesive tape, consisting of a first layer of adhesive, a carrier material, and a second layer of adhesive, which is optionally lined additionally for protection with a so-called liner.

A liner (release paper, release film) is not part of an adhesive tape or label, but is instead only a means for its production, storage or for further processing by die cutting. Unlike an adhesive tape carrier, moreover, a liner is not firmly joined to a layer of adhesive.

The first web-type material is preferably an “adhesive transfer tape”, i.e., an adhesive tape without carrier. Single-layer, double-sided self-adhesive tapes, known as transfer tapes, are constructed such that the pressure-sensitive adhesive layer, which forms the single layer, contains no carrier and is lined only with corresponding release materials, such as siliconized release paper or release films, for example.

With particular preference the first web-type material comprises or consists of a pressure-sensitive adhesive, in other words an adhesive which permits a durable connection to virtually all the substrates under just relatively gentle applied pressure and which after use can be detached from the substrate again substantially without residue. At room temperature, a pressure-sensitive adhesive is permanently tacky, thus having a sufficiently low viscosity and a high initial tack, so that it wets the surface of the respective bond substrate under just gentle applied pressure. The bondability of the adhesive derives from its adhesive properties, and its redetachability from its cohesive properties.

The pressure-sensitive adhesive layer is based preferably on natural rubber, synthetic rubber, or polyurethanes, with the pressure-sensitive adhesive layer preferably consisting of pure acrylate or primarily of acrylate.

For the purpose of improving the adhesive properties, the pressure-sensitive adhesive may have been blended with tackifiers.

Tackifiers, also referred to as tackifying resins, that are suitable in principle are all known classes of compound. Tackifiers are, for example, hydrocarbon resins (for example, polymers based on unsaturated C₅ or C₉ monomers), terpene-phenolic resins, polyterpene resins based on raw materials such as, for example, alpha- or beta-pinene, aromatic resins such as coumarone-indene resins or resins based on styrene or alpha-methylstyrene such as rosin and its derivatives, examples being disproportionated, dimerized or esterified rosin, as for example reaction products with glycol, glycerol or pentaerythritol, to name but a few.

Preference is given to resins without easily oxidizable double bonds such as terpene-phenolic resins, aromatic resins, and, more preferably, resins prepared by hydrogenation, such as hydrogenated aromatic resins, hydrogenated polycyclopentadiene resins, hydrogenated rosin derivatives or hydrogenated polyterpene resins, for example.

Preferred resins are those based on terpene-phenols and rosin esters. Likewise preferred are tackifying resins having a softening point of more than 80° C. according to ASTM E28-99 (2009). Particularly preferred resins are those based on terpene-phenols and rosin esters with a softening point of more than 90° C. according to ASTM E28-99 (2009). Typical quantities for use are 10 to 100 parts by weight based on polymers of the adhesive.

For further improvement in the cable compatibility, the adhesive formulation may optionally have been blended with light stabilizers or primary and/or secondary aging inhibitors.

To improve the processing properties, the adhesive formulation may further have been blended with customary process auxiliaries such as defoamers, deaerating agents, wetting agents or flow control agents. Suitable concentrations are situated in the range from 0.1 up to 5 parts by weight, based on the solids.

With further preference the second web-type material is a carrier material.

Preferably employed presently as carrier material are polymer films or film composites. Such films/film composites may consist of all common plastics used for film production: by way of example, but without restriction, the following may be mentioned:

Polyethylene, polypropylene—especially the oriented polypropylene (OPP) produced by monoaxial or biaxial stretching, cyclic olefin copolymers (COC), polyvinyl chloride (PVC), polyesters—especially polyethylene terephthalate (PET) and polyethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyethersulfone (PES) or polyimide (PI).

These materials are also employed preferably as carrier layer in the first web-type material if a carrier is present in that material.

Carrier material in the sense of the invention encompasses, in particular, all sheet-like structures, examples being two-dimensionally extended films or film sections, tapes with extended length and limited width.

According to another preferred variant of the invention, the second web-type material is viscoelastic.

A viscoelastic polymer layer may be regarded as a fluid of very high viscosity, which exhibits flow (also referred to as “creep”) behavior under compressive load. Such viscoelastic polymers or a polymer layer of this kind possess or possesses to a particular degree the capacity, under slow exposure to force, to relax the forces which act on it/them. They are capable of dissipating the forces into vibrations and/or deformations (which more particularly may also—at least partly—be reversible), and thus of “buffering” the acting forces, and preferably of avoiding mechanical destruction by the acting forces, but advantageously at least of reducing such mechanical destruction or else of at least delaying the time of onset of the destruction. In the case of a force which acts very quickly, viscoelastic polymers customarily exhibit an elastic behavior, in other words the behavior of a fully reversible deformation, and forces which exceed the elasticity of the polymers may cause fracture. In contrast to this are elastic materials, which exhibit the described elastic behavior even under slow exposure to force. By means of admixtures, fillers, foaming or the like, it is also possible for such viscoelastic adhesives to be varied greatly in their properties.

Owing to the elastic fractions of the viscoelastic polymer layer, which in turn make a substantial contribution to the technical adhesive properties of adhesive tapes featuring a viscoelastic carrier layer of this kind, it is not possible for the tension, for example, of a tensile or shearing stress to be relaxed completely. This fact is expressed through the relaxation capacity, which is defined as ((stress(t=0)−stress (t)/stress (t=0))*100%. Viscoelastic carrier layers typically display a relaxation capacity of more than 50%.

Expandable microballoons serve with particular preference for foaming.

Microballoons are elastic hollow spheres having a thermoplastic polymer shell. These spheres are filled with low-boiling liquids or liquefied gas. Shell material used is, in particular, polyacrylonitrile, PVDC, PVC or polyacrylates. Suitable low-boiling fluids are, in particular, hydrocarbons of the lower alkanes, such as isobutane or isopentane, for example, which are enclosed in the form of liquefied gas under pressure in the polymer shell.

The second web-type material may also be or comprise an adhesive.

With further preference the third web-type material comprises or consists of a layer of adhesive, and with further preference the adhesive is a pressure-sensitive adhesive.

Adhesives which can be used as (pressure-sensitive) adhesives are all of those identified above.

According to one particularly advantageous embodiment of the invention, a three-layer product is laminated together. To both sides of an adhesive or nonadhesive, acrylate-based foam carrier (second web-type material), pressure-sensitive adhesives (first and third web-type materials) are laminated on.

Not ruled out in accordance with the invention is the subjection of some or all of the surfaces involved in the method to a first physical pretreatment (optionally also a plasma treatment).

Lastly, the invention does not rule out a further web or two further webs being passed between the second surface of the first web-type material and/or the second surface of the second web-type material and/or the second surface of the third web-type material and also the cylinder surface of one or the cylinder surfaces of both roll or rolls, such further webs possibly being reusable. These further webs serve to reduce damage to the first and/or second and/or third web-type materials.

The problem posed by the invention is resolved in the form that plasma treatment and lamination take place simultaneously. For this purpose the plasma is formed in the lamination gap. The radicals generated by the plasma on the surface of the carrier and also on the surface of the adhesive are unable to be consumed by reaction with atmospheric oxygen and are therefore unable to interact with the counterpart, since the time between generation and lamination is close to zero.

Consequently there are significant boosts to peel adhesion which were not expected beforehand, and which are also not achievable by means of separate pretreatments.

The method is able to achieve a boost in the peel adhesion between the layers across a wide range of pressure-sensitive adhesives and carrier materials.

The method is robust and is not dependent on optimized treatment for each adhesive and/or on optimized treatment for each carrier material.

The effect of the method taught is synergistic, i.e., is more than the sum of the individual effects of the treatment of carrier material or adhesive.

By virtue of the invention, the following desirable properties can be united in an adhesive tape:
high peel strength
high initial adhesion
high shear resistance
high temperature resistance
suitability for carrier materials with low surface energy (LSE)

A plurality of figures show advantageous variants of the method of the invention, without wishing to evoke restriction of any kind at all.

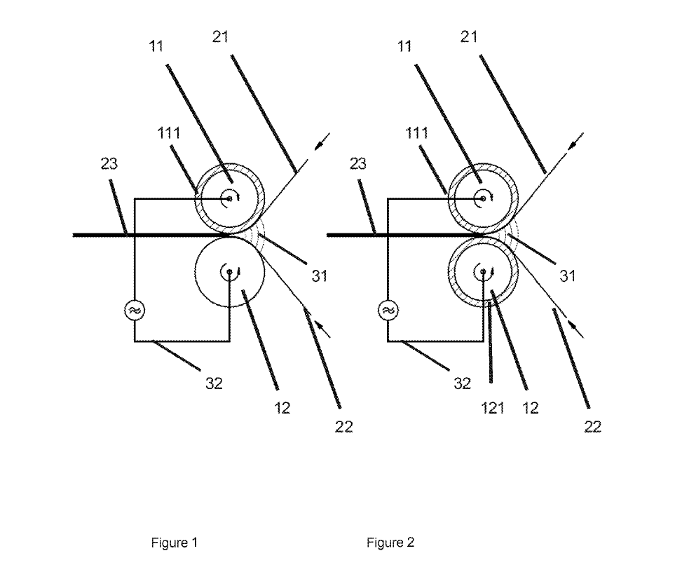

The figures show advantageous embodiments of the method, without wishing to restrict the invention in any form. In FIG. 1, a laminating gap is shown, formed by a pressure roll 11 and by a counterpressure roll 12, which builds up the opposing pressure desired for lamination. The rolls 11 and 12, which are of equal size, run in opposite directions, but at identical peripheral speed.

There is a layer of a dielectric 111 on the pressure roll 11.

On account of the voltage 32 between the rolls 11, 12, a plasma 31 is formed in the laminating gap.

The laminating gap is fed with a first web-type material 21 and a second web-type material 22, continuously and with the same web direction. In this gap, the first web-type material 21 and the second web-type material 22 are laminated together, each by their first surface, to produce a laminate 23.

The first web-type material 21 is a layer of adhesive; the second web-type material 22 is a carrier.

Both first surfaces of the first web-type material 21 and of the second web-type material 22 are treated over the full area with a plasma 31, specifically such that the plasma 31 acts on the two first surfaces continuously, beginning ahead of the laminating gap and on into the laminating gap.

FIG. 2 differs from FIG. 1 in that both roll surfaces are each equipped with a dielectric 111, 121.

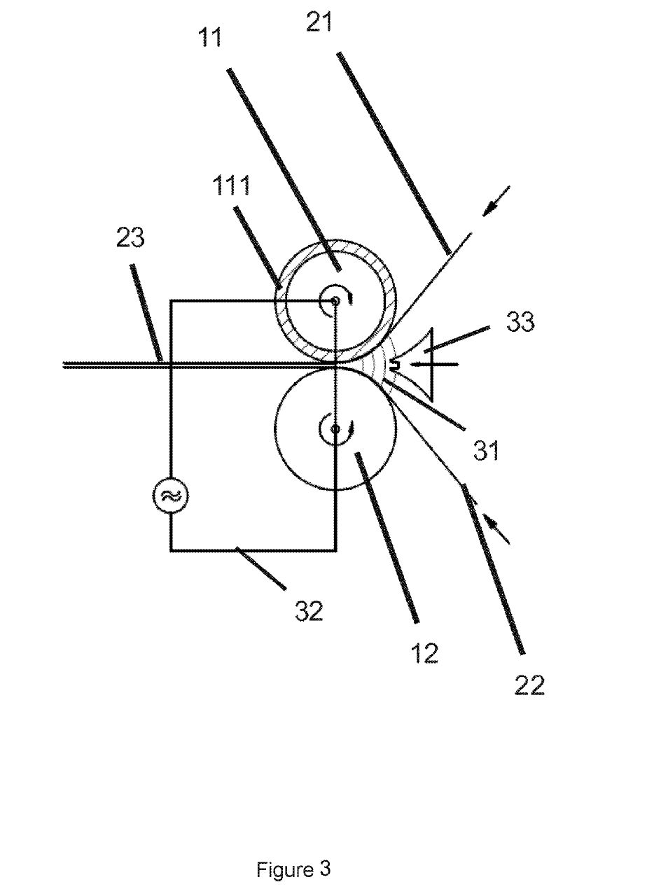

FIG. 3 differs from FIG. 1 in that a nozzle 33, which may be made of plastic, is present. This nozzle serves merely to supply gas to the plasma 31—nitrogen, for example.

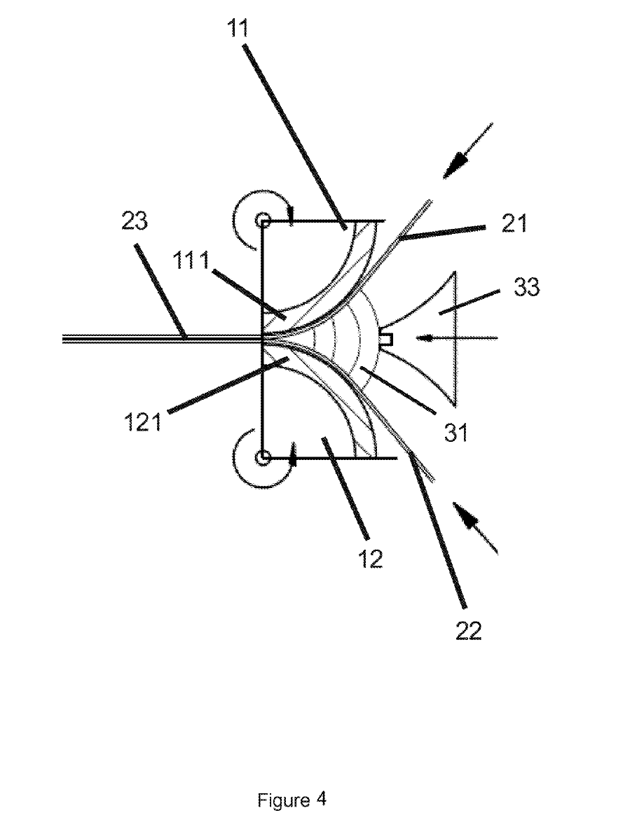

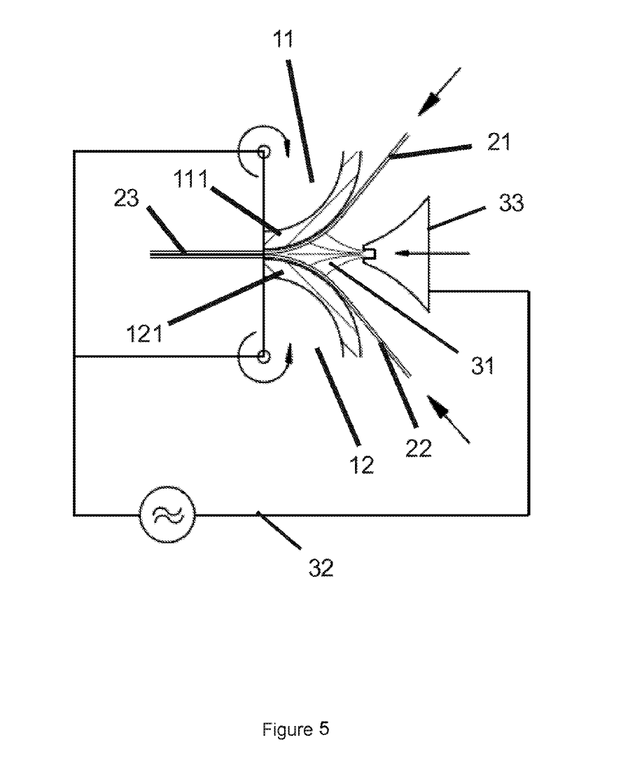

FIG. 4 represents a simplified detail of FIG. 3, showing only one quarter of the rolls 11, 12. Both roll surfaces are equipped with respective dielectrics 111, 121.

FIG. 5 shows that the plasma 31 is generated by the linear nozzle 33, on account of the voltage 32 between the rolls 11, 12 and the nozzle 33.

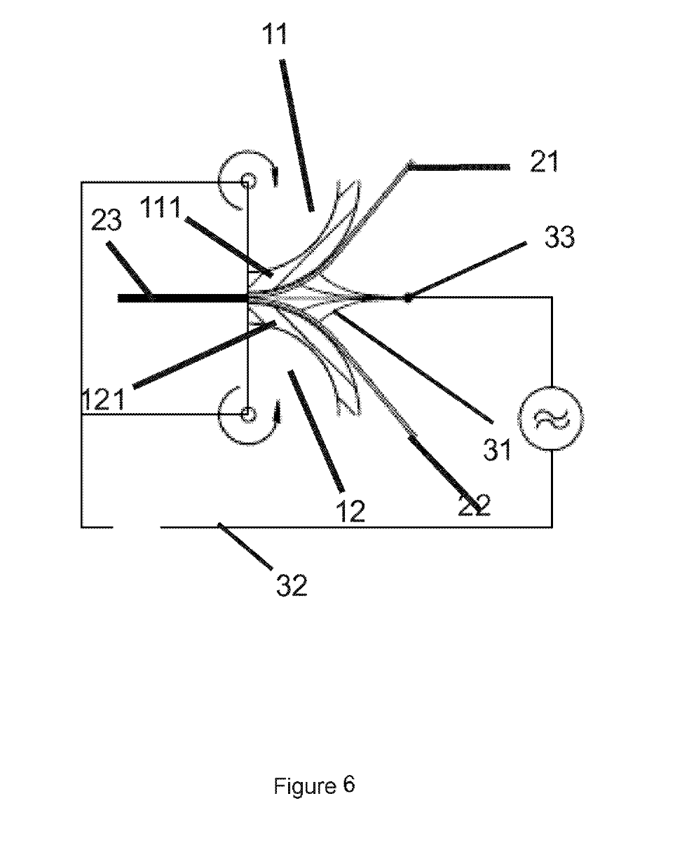

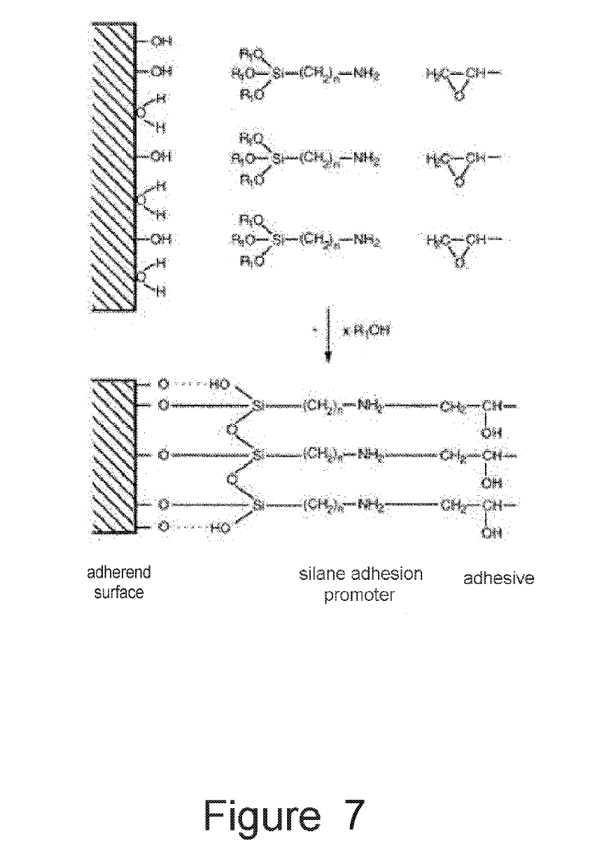

In FIG. 6 the nozzle 33 from FIG. 5 is replaced with a metallic wire 33 which extends parallel to the laminating gap.

### TEST METHODS

T-Peel Adhesion

The T-peel adhesion is determined when the test conditions of 23° C.+/−1° C. temperature and 50%+/−5% relative atmospheric humidity. Fundamentally, a two-layer assembly is produced, and the peel adhesion (or release force) of this assembly is measured by peeling in a geometry which when viewed from the side resembles a “T” line on its side.

The intention below is to illustrate the invention with a number of examples, without wishing thereby to bring about any kind of restriction whatsoever.

In tests, a search was made for optimum parameters of the corona pretreatment for the anchoring of PET and polyester and also various acrylate-based adhesives. For a straight-acrylate composition, however, it was not possible in any case to produce conditions in which the adhesive went into cohesive failure.

The composition of the straight-acrylate composition (an example of a typical acrylate composition) is as follows:

| | |
|---|---|
| 2-Ethylhexyl acrylate | 68 wt % |
| Isobornyl acrylate | 30 wt % |
| Acrylic acid | 2 wt % |

Added to this is 0.4 wt % of Al chelate (based on the above 100%).

Whereas in the experiments with corona pretreatment of the carrier, maximum T-peel forces of 6.6 N/cm came about, cohesive fractures of the adhesive were obtained in the case of plasma lamination. The values for cohesive failure of the adhesive in this case are 8.3 N/cm.

If only the polyester film was treated with the system of plasma lamination, and the adhesive was laminated on without treatment, by hand, it was possible to raise the anchoring force of 3.2 N/cm by corona to 4.3 N/cm by means of the method of the invention.

Results:

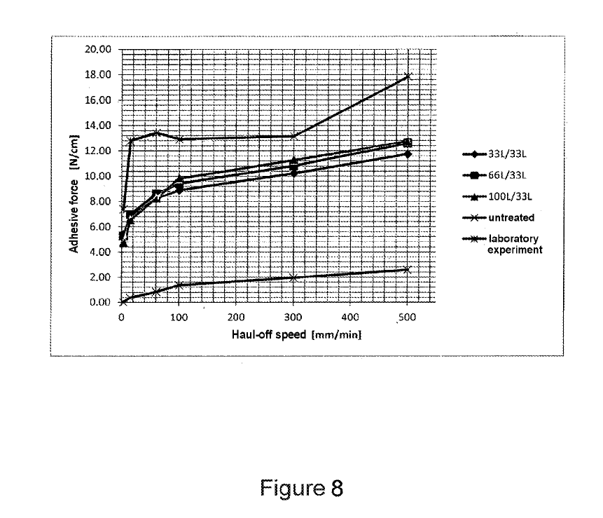

For further tests, investigations were carried out on a carrier/adhesive system which had already been optimized for corona beforehand. The carrier is an unfoamed acrylate composition (900 μm thickness), the adhesive a straight-acrylate composition (applied to carrier at 50 g/m²). In the graph shown (see FIG. 8), the “laboratory experiment” test takes place on the inventive system for plasma lamination. T-peel testing was carried out with different haul-off speeds in the range from 3 to 500 mm/min. A significant increase is apparent relative to the corona treatments. In the range of low haul-off speeds in particular, it was possible to boost the performance by in some cases up to 100%. Under certain circumstances and with slow haul-off speeds, even relatively large tears from the core were observed, something which was not possible in the case of the corona pretreatment.

The designation 33L/33L here stands for corona treatment of the surface of the carrier and the surface of the adhesive, which are laminated together, with air (“L”), the surfaces specifically being treated in each case with 33 W*min/m² (“33”). Similar comments apply in respect of the following two graphs.

1. A method for increasing the adhesion between the first surface of a first web-type material and a first surface of a second web-type material, said method comprising:
feeding the first web-type material and the second web-type material continuously and with identical web direction to a laminating gap, in which the first web-type material and the second web-type material are laminated together each by their first surface,
treating both first surfaces of the first web-type material and of the second web-type material over the full area with a plasma, specifically such that the plasma, beginning ahead of the laminating gap on into the laminating gap, acts continuously on the two first surfaces,
wherein the laminating gap is formed by a pressure roll and a counter-pressure roll, and at least one of the surfaces of the rolls, or both, is or are furnished with a dielectric,
and the first web-type material has a layer of adhesive arranged in the first web-type material in such a way that it forms the first surface of the first web-type material.

2. The method as claimed in claim 1,
wherein
an arbitrary point on the plasma-treated surface of the first web-type material and/or the second web-type material travels the path from the start of the plasma treatment on into the laminating gap in a timespan of less than 2.0 s.

3. The method as claimed in claim 1,
wherein
a third web-type material is fed to the laminating gap in such a way that the second web-type material lies between the first and third web-type materials.

4. The method as claimed in claim 1,
wherein
the laminating gap is fed not only with the first and second web-type materials but also with a multiplicity of further web-type materials, with feeding taking place in such a way that the individual web-type materials enter the laminating gap between the first and second web-type materials, and the individual further web-type materials are selected such that in the laminating gap a non-adhesive carrier layer and a second non-adhesive carrier layer are never laminated directly to one another.

5. The method as claimed in claim 1,
wherein
the rolls have a diameter between 50 to 500 mm.

6. The method as claimed in claim 1,
wherein
the dielectric is a layer of ceramic, glass, plastic, rubber or silicone.

7. The method as claimed in claim 1,
wherein
the thickness of the layer of the dielectric on the roll or rolls is between 1 to 5 mm.

8. The method as claimed in claim 1,
wherein the plasma is generated between one or more nozzles and the rolls, optionally on operation with compressed air or N2.

9. The method as claimed in claim 1,
wherein
the plasma is generated by means of a linear electrode with gas exit opening, optionally one which extends over the entire length of the laminating gap and which further optionally has a constant distance from the laminating gap over the entire length of the laminating gap.

10. The method as claimed in claim 1,
wherein
the treatment distance of the plasma generator from the laminating gap is 1 to 100 mm.

11. The method as claimed in claim 1,
wherein
the plasma generator can be displaced in its height perpendicularly to the plane which in turn lies perpendicular to the plane defined by the roll axes, optionally simultaneously in its height and in its distance from the laminating gap.

12. The method as claimed in claim 1,
wherein
the speed with which the webs are fed into the laminating gap is between 0.5 to 200 m/min.

13. The method as claimed in claim 1,
wherein
the second web-type material is a carrier material.

14. The method as claimed in claim 1,
wherein
the third web-type material has a layer of adhesive which is arranged in the third web-type material in such a way that it forms outer surface of the third web-type material and is laminated together with the second web-type material.

15. The method as claimed in claim 1,
wherein
the first web-type material is a layer of pressure-sensitive adhesive based on natural rubber, synthetic rubber or polyurethanes, the layer of pressure-sensitive adhesive consisting optionally of pure acrylate or predominantly of acrylate (with a thermal crosslinker system and/or hot melt and/or UV-crosslinked and/or UV-polymerized).

16. The method as claimed in claim 1,
wherein
the layer of pressure-sensitive adhesive forms a carrier-free, single-layer, double-sided adhesive tape.

17. The method as claimed in claim 1,
wherein
the layer of pressure-sensitive adhesive is applied on a carrier.

18. The method as claimed in claim 1,
wherein
the thickness of the layer of pressure-sensitive adhesive or of the adhesive tape formed therewith is ≧20 μm and/or not more than ≦2500 μm.
